(19) United States
(12) Patent Application Publication
(10) Pub. No.: US 2025/0339740 A1
(43) Pub. Date: Nov. 6, 2025

(54) GOLF BALL WITH AMORPHOUS ALLOY STRIPS

(71) Applicant: James Kang, Las Vegas, NV (US)

(72) Inventor: James KANG, Las Vegas, NV (US)

(73) Assignee: James KANG, Las Vegas, NV (US)

(21) Appl. No.: 18/958,215

(22) Filed: Nov. 25, 2024

Related U.S. Application Data
(60) Provisional application No. 63/642,906, filed on May 6, 2024.

(51) Int. Cl. A63B 37/00; B23K 35/02; B23K 35/30; C22C 45/04

(52) U.S. Cl. CPC A63B 37/0039; A63B 37/0045; A63B 37/0075; A63B 37/0076; B23K 35/0233; B23K 35/3033; C22C 45/04; A63B 37/0026; A63B 37/0052; A63B 2209/00

(57) ABSTRACT

According to an embodiment, it is an article comprising an inner core; an outer layer; and an intermediate layer comprising an amorphous alloy; and wherein the intermediate layer is placed between the outer layer and the inner core; and wherein the article is a golf ball.

### CROSS-REFERENCE TO RELATED APPLICATIONS

This application claims the benefit under 35 U.S.C § 119 of U.S. Provisional Application No. 63/642,906, filed on 6 May 2024 which is hereby incorporated by reference in its entirety.

### FIELD OF INVENTION

This disclosure relates generally to a golf ball and is more particularly to a golf ball having a layer comprising amorphous materials.

### BACKGROUND

In this section prior art is cited:

“The game of golf is an increasingly popular sport at both amateur and professional levels. A wide range of technologies related to the manufacture and design of golf balls are known in the art. Such technologies have resulted in golf balls with a variety of play characteristics and durability. For example, some golf balls have a better flight performance than other golf balls. Some golf balls with a good flight performance do not have a good feel when hit with a golf club. Some golf balls with good performance and feel lack durability. Thus, it would be advantageous to make a durable golf ball with a good flight performance that also has a good feel.” [U.S. Patent Publication US20130324322A1, titled, “Golf Ball with Lattice Reinforced Layer”.]

“The flight of a golf ball is determined by many factors, however, the majority of the properties that determine flight are outside of the control of a golfer. While a golfer can control the speed, the launch angle, and the spin rate of a golf ball by hitting the ball with a particular club, the final resting point of the ball depends upon golf ball construction and materials, as well as environmental conditions, e.g., terrain and weather. Since flight distance and consistency are critical factors in reducing golf scores, manufacturers continually strive to make even the slightest incremental improvements in golf ball flight consistency and flight distance, e.g., one or more yards, through various aerodynamic properties and golf ball constructions. Flight consistency is a significant problem for manufacturers because many golf ball dimple patterns and/or dimple shapes that yield increased flight distances also result in asymmetric flight performance. Asymmetric flight performance prescribes that the overall flight distance is a function of ball orientation when struck with a club. [U.S. Patent Publication US 20100075776A1, titled, “Golf ball with improved flight performance”.]

### SUMMARY

The following is a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, it is an article comprising: an inner core; an outer layer; and an intermediate layer comprising an amorphous alloy, wherein a thickness of the intermediate layer is at most 0.1 mm; and wherein the intermediate layer is placed between the outer layer and the inner core.

According to an embodiment of the article, the article is a golf ball.

According to an embodiment of the article, the intermediate layer is made in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the article, the intermediate layer is formed from longitudinal strips connecting the poles; and wherein the intermediate layer is made as a single piece configured to wrap around the article.

According to an embodiment of the article, the intermediate layer is formed as longitudinal strips connecting one of the poles and the equator; and wherein the intermediate layer is made as two pieces configured to wrap around the article.

According to an embodiment of the article, the intermediate layer is glued to the inner core.

According to an embodiment of the article, the article further comprises an additional layer, wherein the additional layer comprises a geometric structure of a first material; wherein the geometric structure creates plurality of pockets for a second material; wherein the second material comprises a fluid; and wherein a pressure of the fluid is adjustable.

According to an embodiment of the article, the geometric structure comprises a honeycomb pattern.

According to an embodiment of the article, the fluid is air.

According to an embodiment of the article, the additional layer is placed between the inner core and the intermediate layer.

According to an embodiment of the article, the outer layer comprises one or more of Urethane, Surlyn, and Balata.

According to an embodiment of the article, the inner core comprises one or more of polybutadiene, thermoplastic elastomers, liquid, and gel.

According to an embodiment of the article, the article features a dimple design on the outer layer.

According to an embodiment of the article, the thickness of the intermediate layer is 0.08 mm.

According to an embodiment of the article, the amorphous alloy comprises a Nickel-Based Brazing Foil comprising at least 75% Nickel by weight.

According to an embodiment of the article, the amorphous alloy comprises a Nickel-Based Brazing Foil comprising at least 85% Nickel by weight.

According to an embodiment, it is an article comprising: an inner core; an outer layer; and an intermediate layer comprising an amorphous alloy, wherein the amorphous alloy comprises Nickel; and wherein the intermediate layer is placed between the outer layer and the inner core.

According to an embodiment of the article, the article is a golf ball.

According to an embodiment of the article, the intermediate layer is made in a shape to wrap around the golf ball, wherein the shape is in a form of a gore, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the article, the intermediate layer is formed from longitudinal strips connecting the poles; and wherein the intermediate layer is made as a single piece configured to wrap around the article.

According to an embodiment of the article, the intermediate layer is formed as longitudinal strips connecting one of the poles and the equator; and wherein the intermediate layer is made as two pieces configured to wrap around the article.

According to an embodiment of the article, the intermediate layer is glued to the inner core.

According to an embodiment of the article, the article further comprises an additional layer, wherein the additional layer comprises a geometric structure of a first material; wherein the geometric structure creates plurality of pockets for a second material; wherein the second material comprises a fluid; and wherein a pressure of the fluid is adjustable.

According to an embodiment of the article, the geometric structure comprises a honeycomb pattern.

According to an embodiment of the article, the fluid is air.

According to an embodiment of the article, the additional layer is placed between the inner core and the intermediate layer.

According to an embodiment of the article, the outer layer comprises one or more of Urethane, Surlyn, and Balata.

According to an embodiment of the article, the inner core comprises one or more of polybutadiene, thermoplastic elastomers, Liquid, and gel.

According to an embodiment of the article, the article features a dimple design on the outer layer.

According to an embodiment of the article, the amorphous alloy comprises in percentage weights Boron 1-5%, Chromium 5-10%, Iron 1-5%, Nickel 75-92%, Silicon 1-5%, and a possible trace of Cobalt impurity.

According to an embodiment of the article, the amorphous alloy comprises in percentage weights Boron 1-5%, Iron 0-0.5%, Nickel 85-95%, Silicon 1-5% and a possible trace of Cobalt impurity.

According to an embodiment of the article, wherein a thickness of the intermediate layer is at most 0.1 mm.

According to an embodiment of the article, the thickness of the intermediate layer is 0.08 mm.

According to an embodiment, it is a method comprising: creating an inner core of an article; creating an intermediate layer comprising an amorphous alloy, wherein a thickness of the intermediate layer is at most 0.1 mm; and creating an outer layer enclosing the intermediate layer.

According to an embodiment of the method, the article is a golf ball.

According to an embodiment of the method, the intermediate layer is made in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the method, the intermediate layer is formed from longitudinal strips connecting the poles; and wherein the intermediate layer is made as a single piece configured to wrap around the article.

According to an embodiment of the method, the intermediate layer is formed as longitudinal strips connecting one of the poles and the equator; and wherein the intermediate layer is made as two pieces configured to wrap around the article.

According to an embodiment of the method, the pieces of the intermediate layer are stamped.

According to an embodiment of the method, the amorphous alloy is cast as strips on a cold roller.

According to an embodiment of the method, the pieces of the intermediate layer are injection molded.

According to an embodiment of the method, the intermediate layer is glued to the inner core.

According to an embodiment of the method, the article further comprises an additional layer, wherein the additional layer comprises a geometric structure of a first material; wherein the geometric structure creates plurality of pockets for a second material; wherein the second material comprises a fluid; and wherein a pressure of the fluid is adjustable.

According to an embodiment of the method, the geometric structure comprises a honeycomb pattern.

According to an embodiment of the method, the fluid is air.

According to an embodiment of the method, the additional layer is placed between the inner core and the intermediate layer.

According to an embodiment of the method, the outer layer comprises one or more of Urethane, Surlyn, and Balata.

According to an embodiment of the method, the inner core comprises one or more of polybutadiene, thermoplastic elastomers, Liquid, and gel.

According to an embodiment of the method, the article features a dimple design on the outer layer.

According to an embodiment of the method, the amorphous alloy comprises a Nickel-Based Brazing Foil comprising at least 75% Nickel by weight.

According to an embodiment of the method, the amorphous alloy comprises a Nickel-Based Brazing Foil comprising at least 85% Nickel by weight.

According to an embodiment of the method, the thickness of the intermediate layer is 0.08 mm.

According to an embodiment, it is a method comprising: creating an inner core of an article; creating an intermediate layer comprising an amorphous alloy, wherein the amorphous alloy comprises Nickel; and creating an outer layer enclosing the intermediate layer.

According to an embodiment of the method, the article is a golf ball.

According to an embodiment of the method, the intermediate layer is stamped in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the method, the intermediate layer is formed from longitudinal strips connecting the poles; and wherein the intermediate layer is made as a single piece configured to wrap around the article.

According to an embodiment of the method, the intermediate layer is formed as longitudinal strips connecting one of the poles and the equator; and wherein the intermediate layer is made as two pieces configured to wrap around the article.

According to an embodiment of the method, pieces of the intermediate layer are stamped.

According to an embodiment of the method, the amorphous alloy is cast as strips on a cold roller.

According to an embodiment of the method, pieces of the intermediate layer are injection molded.

According to an embodiment of the method, the intermediate layer is glued to the inner core.

According to an embodiment of the method, the article further comprises an additional layer; wherein the additional layer comprises a geometric structure of a first material; wherein the geometric structure creates plurality of pockets for a second material; wherein the second material comprises a fluid; and wherein a pressure of the fluid is adjustable.

According to an embodiment of the method, the geometric structure comprises a honeycomb pattern.

According to an embodiment of the method, the fluid is air.

According to an embodiment of the method, the additional layer is placed between the inner core and the intermediate layer.

According to an embodiment of the method, the outer layer comprises one or more of Urethane, Surlyn, and Balata.

According to an embodiment of the method, the inner core comprises one or more of polybutadiene, thermoplastic elastomers, Liquid, and gel.

According to an embodiment of the method, the article features a dimple design on the outer layer.

According to an embodiment of the method, the amorphous alloy comprises in percentage weights Boron 1-5%, Chromium 5-10%, Iron 1-5%, Nickel 75-92%, Silicon 1-5%, and a possible trace of Cobalt impurity.

According to an embodiment of the method, the amorphous alloy comprises in percentage weights Boron 1-5%, Iron 0-0.5%, Nickel 85-95%, Silicon 1-5% and a possible trace of Cobalt impurity.

According to an embodiment of the method, wherein a thickness of the intermediate layer is at most 0.1 mm.

According to an embodiment of the method, the thickness of the intermediate layer is 0.08 mm.

### BRIEF DESCRIPTION OF THE FIGURES

Aspects of the present invention will now be described in more detail, with reference to the appended drawings showing exemplary embodiments of the present invention, in which:

FIG. 1 shows a golf ball on impact with the golf club where the golf ball is compressed just before leaving the golf club according to an embodiment.

FIG. 2 shows an amorphous alloy hysteresis cycle according to an embodiment.

FIG. 3 shows a metal ball bouncing distance on a crystalline metal and an amorphous alloy (metallic glass) according to an embodiment.

FIG. 4 shows a pattern of amorphous alloy material formed to wrap around a golf ball according to an embodiment.

FIG. 5 shows a golf ball wrapped with an amorphous alloy layer according to an embodiment.

FIG. 6 shows a golf ball wrapped with an amorphous alloy layer according to another embodiment.

FIG. 7 shows an example of thin chips or shapes that are glued to form an amorphous layer according to prior art.

FIG. 8 shows golf ball behavior in compression for amorphous alloy strip versus amorphous chip powder wrapped around the golf core.

FIG. 9 shows an example of amorphous alloy materials and their compositions according to an embodiment.

FIG. 10 shows an example of a golf ball comprising an amorphous layer according to an embodiment.

FIG. 11 shows an example golf ball comprising an amorphous layer and a geometric structure according to an embodiment.

FIG. 12 shows an example geometric structure layer according to an embodiment.

FIG. 13 shows athletes jumping on a trampoline according to an embodiment.

FIG. 14 shows the potential net gain in distance as the initial velocity of the ball coming off the face of the club according to an embodiment.

FIG. 15 shows potential energy regained by different materials used in forming the layers of a golf ball to store and return energy.

FIG. 16 shows a relation between launch angle and backspin rate according to an embodiment.

FIG. 17 shows a table showing the relation of launch angle and spin rate according to an embodiment.

FIG. 18 shows an example of the law of conservation of momentum according to an embodiment.

FIG. 19 shows a schematic Time-Temperature-Transformation (TTT) diagram that shows crystallization kinetics of amorphous metals vs. crystalline metals.

### DETAILED DESCRIPTION

### Definitions and General Techniques

For simplicity and clarity of illustration, the figures illustrate the general manner of construction. The description and figures may omit the descriptions and details of well-known features and techniques to avoid unnecessarily obscuring the present disclosure. The figures may exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Other specific forms may embody the present invention without departing from its spirit or characteristics. The embodiments described are in all respects illustrative and not restrictive. Therefore, the appended claims, rather than the description herein, indicate the scope of the invention. All variations which come within the meaning and range of equivalency of the claims are within their scope.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein are acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed to achieve desirable results. In certain circumstances, multitasking and parallel processing may be advantageous. Moreover, the separation of various system components in the implementations should not be understood as requiring such separation in all implementations, and it should be understood that the described program components and systems may be integrated together into a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

The present disclosure may be embodied in other specific forms without departing from its spirit or characteristics. The embodiments described are to be considered in all respects only as illustrative and not restrictive. The scope of the disclosure is, therefore, indicated by the appended claims rather than by the foregoing descriptions. All changes which come within the meaning and range of equivalency of the claims are to be embraced within their scope.

Unless otherwise defined herein, scientific, and technical terms used in connection with the present disclosure shall have meanings that are commonly understood by those of ordinary skill in the art. Further, unless otherwise required by context, singular terms shall include pluralities, and plural terms shall include the singular.

The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include”, “have”, and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left”, “right”, “front”, “back”, “top”, “bottom”, “over”, “under”, and the like, in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

As defined herein, two or more elements are “integral” if they are comprised of the same piece of material. As defined herein, two or more elements are “non-integral” if each is comprised of a different piece of material.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

It will be understood that when an element, layer, region, or component is referred to as being “on,” “connected to,” or “coupled to” another element, layer, region, or component, it can be directly on, connected to, or coupled to the other element, other layer, other region, other component, or one or more intervening elements, layers, regions, or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or it is not the only element, and one or more intervening elements or layers may also be present between the two elements or layers.

The following terms and phrases, unless otherwise indicated, shall be understood to have the following meanings.

As used herein, the term “Coefficient of Restitution (COR)” may refer to a dimensionless parameter that measures the elasticity of a collision between two bodies. It quantifies how much kinetic energy remains after a collision, relative to the energy before the collision.

As used herein, the term “perfect spring” in the context of mechanics may refer to an idealized spring that obeys Hooke's Law perfectly, without any deviations due to material imperfections or external factors. According to Hooke's Law, the force exerted by a spring is directly proportional to its displacement.

As used herein, the term “Hysteresis cycle” may refer to a lag between the applied force (or field) and the resulting deformation or response within a material and may particularly indicate when this force is applied cyclically. The hysteresis cycle describes how materials respond to changes in applied forces, resulting in a looped behavior on a graph representing input versus output. As used herein “Spin” refers to rotational movement of the golf ball around its axis when it is in the air. It includes various types of spin, such as backspin, sidespin, and topspin. Spin affects the ball's flight trajectory, distance, and control. Backspin, a specific type of spin, occurs when the golf ball rotates backward as it moves forward.

### Problem Defined

### Lost Energy at Impact

When golf balls are dropped on a hard surface, they rebound back approximately 70%-80% of the distance. A hard “distance” golf ball will rebound 0.8 (80%) of the original height, whereas softer “competitors” ball will have a rebound ratio of only 0.7 (70%).

This 20% to 30% loss in rebound height is mainly attributable to two factors:

First, the energy is absorbed by the polymers used to construct Golf balls, such as Urethane, Surlyn®, and rubber, during the compression and decompression cycle, and mainly lost as heat or noise.

Second, the mismatch of the timing that a ball and a club spend storing and releasing their compressive energies. A golf ball is in contact with the club face for about 0.01 seconds. Metal face/Club face of driver stores and releases energy significantly quicker than golf balls during impact. This is the case where the golf ball leaves the contact surface of the golf club while it is in the middle of releasing its stored compressive energy. Any energy stored in the ball after it leaves the surface of a golf club cannot contribute to increasing the speed of the ball.

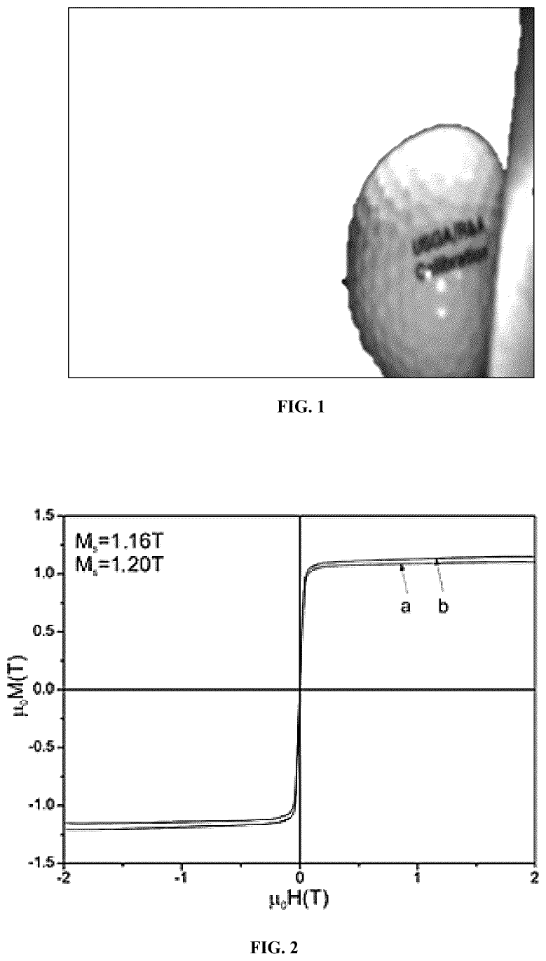

FIG. 1 shows a golf ball on impact with the golf club where the golf ball is compressed just before leaving the golf club according to an embodiment. The force of the clubhead on the ball causes the ball to compress and apply an equal amount of force on the club. The high-speed shot of the ball leaving the face of a driver shows that the ball is compressing and decompressing, which shows release of stored energy. The ball is in the process of releasing its compressed energy, but it is no longer in contact with the club face. This wasted momentum does little to contribute to ball speed.

For irons and smaller woods, where little face deflection is possible and most of the energy of the impact is stored within the ball, the net energy loss is between 20% to 25%, nearly the same as a solid concrete floor. Modern 460 CC drivers, where the term “460 CC” refers to the size of the clubhead, which is measured in cubic centimeters (cc), made of Titanium can store some of the energy on the club hitting surface and return nearly 10% more of the lost energy at impact. This is accomplished through storing the energy of impact on the titanium face through spring effect and returning the energy to the ball as it leaves the surface of the club. Coefficient Of Restitution (COR) established by United States Golf Association (USGA) is 82.2% indicating that the maximum energy transferred from the clubhead to the ball can reach a maximum of 82.2% of the clubhead's initial speed upon impact. If it is assumed that a golf ball only generates 77% COR off a solid plate, (82.2%-77%=5.20%) then the actual speed of COR increase is 6.8% (5.2% increase over the baseline 77% is (5.2×100)/(77)=6.8%) compared to the bouncing off of a solid plate.

### Spin Rate and its Effect on Distance and Control

Most golf balls spin too much during drives and not enough during short iron's shots.

There is a clear compromise between distance gained by hard golf balls and the ability to control and feel gained by softer balls preferred by low handicap golfers. One of the main limitations of hard golf balls is that the grooves of irons cannot dig into the ball and generate backspin on the ball. Softer balls allow players to control the flight trajectory and landing patterns with iron shots. In addition, this softer feel is considered to improve the control of the ball speed during putting and iron shots.

### Solution

Reduce Energy Lost during Compression Cycle by utilizing materials and structures that are more efficient than current solid polymers such that greater percentage of momentum at impact can be directed to generate ball speed.

Reduce backspin on drives but increase backspin on iron shots by distributing weight closer to the outer surface to reduce spin rate by conservation of angular momentum. This can be synchronized with launch angle and club head speed to optimize launch parameters.

Suitable materials for achieving the above solution are amorphous alloys as the amorphous alloys are perfect springs. Amorphous alloys do not lose any energy during compressive cycles.

FIG. 2 shows an amorphous alloy hysteresis cycle according to an embodiment. Amorphous alloys' hysteresis cycle is a straight line. A straight line typically indicates that the system or material exhibits no hysteresis, meaning that the input and output are perfectly proportional, and there is no lag or energy dissipation. In such a case, the system's response is the same during both loading and unloading, following a linear path rather than forming a loop. A straight line suggests that there is no internal friction, resistance, or energy dissipation within the system. All energy input is stored elastically and fully recovered. Further, the absence of a loop and the presence of a straight line indicate that there is no history-dependence in the system's response. The output at any point is solely a function of the current input, without any lag from previous states.

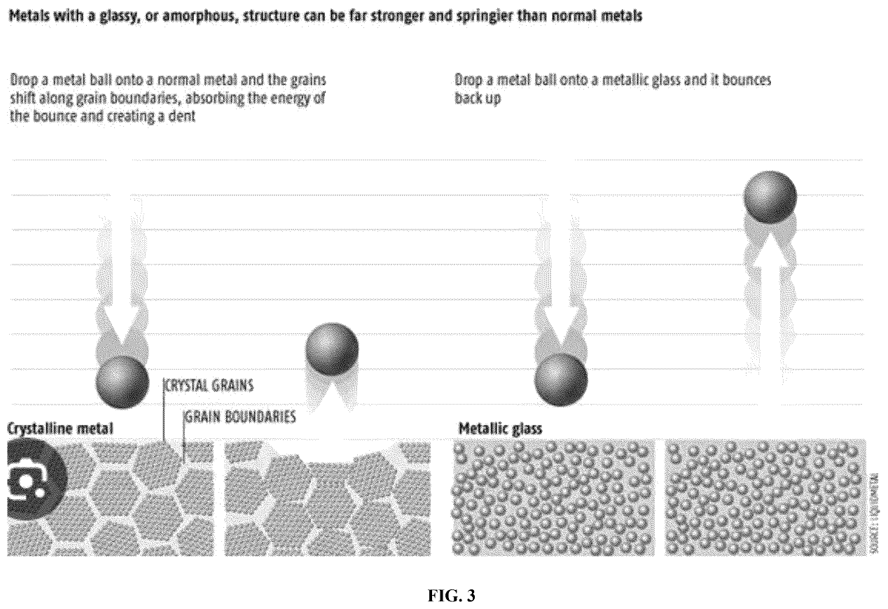

FIG. 3 shows a metal ball bouncing distance on a crystalline metal and an amorphous alloy (metallic glass) according to an embodiment. Amorphous alloys return 100% of the impact energy while there is a significant loss of the impact energy on the crystalline metal, which is reflected in the bouncing distance of the metal ball after the impacts on the surface of the crystalline metal and the amorphous alloy.

An amorphous alloy (also referred to as metallic glass) layer, designed to store and return a significant portion of the compressive energy of the golf ball at impact, can reduce energy lost due to internal friction by 20%. Amorphous alloys return 100% of the impact energy. Since the softer top layer, as well as the supporting core layer, are less efficient at storing and releasing energy, not all the loss of energy can be eliminated.

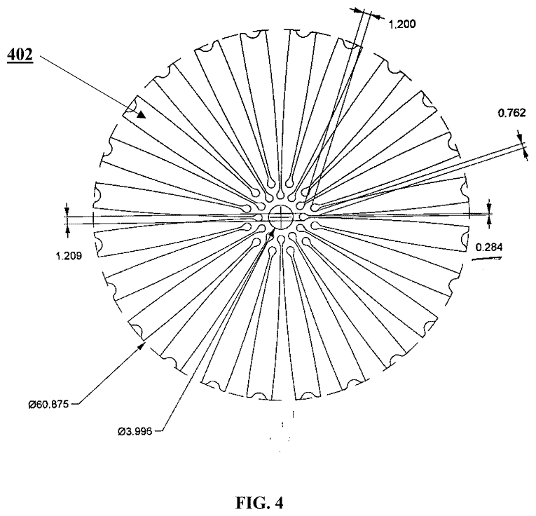

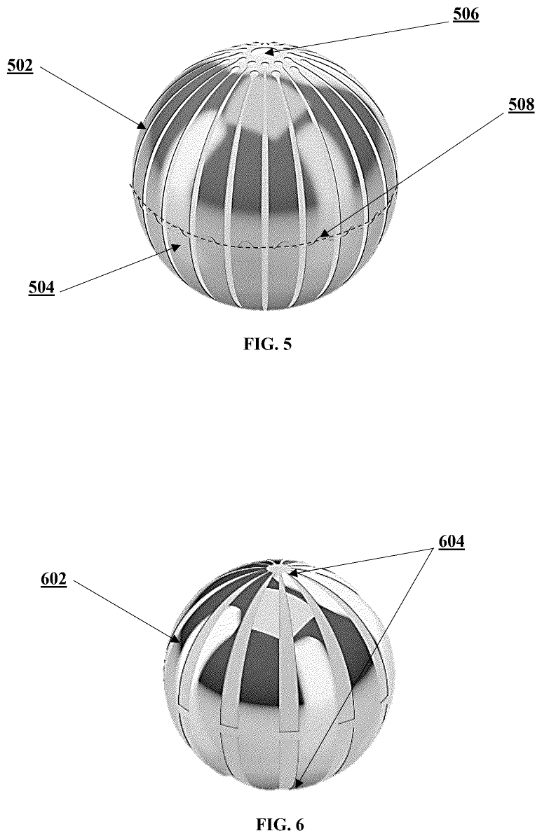

FIG. 4 shows a pattern of amorphous alloy material formed in a shape 402 to wrap around a golf ball according to an embodiment. Amorphous alloy sheet is cut in predetermined shapes, as a single piece, or as two pieces to wrap around the entire ball. FIG. 5 shows a golf ball wrapped with an amorphous alloy layer according to an embodiment. FIG. 5 shows two pieces 502 and 504 made in similar pattern as a predetermined shape 402 that may be stamped and glued to the golf ball. Any strong glue that can hold the amorphous layer intact with the core could be used to glue the pieces to the ball. The predetermined shape to wrap around the golf ball is in a form of gores, where gores are wedge-shaped strips narrowing toward poles, one of the poles shown as 506 and wider at an equator 508. Poles are two points on a surface of the golf ball where an axis of rotation intersects the surface, and the equator is an imaginary line that is perpendicular to the axis of the golf ball and equidistant from the poles and runs around the middle of the golf ball. The equator would also be referred to as a “great circle”. The great circle of the earth is referred to as the equator. In an embodiment, the gores may be connected at poles forming a single piece instead of plurality of longitudinal pieces. In an embodiment, the pieces may be stamped as plurality of longitudinal pieces in the shape of gores. The plurality of longitudinal pieces may be glued individually to the core.

The intermediate layer is formed as longitudinal strips connecting one of the poles and the equator where the intermediate layer is made as two pieces configured to wrap around the article as shown in FIG. 5. The intermediate layer is formed from longitudinal strips connecting the poles where the intermediate layer is made as a single piece configured to wrap around the article as shown in FIG. 6.

FIG. 6 shows a golf ball wrapped with an amorphous alloy layer according to another embodiment. FIG. 6 shows a single piece 602 made in a pattern or predetermined shape (cut pattern is not shown) that may be stamped and glued to the golf ball. The pieces made of amorphous alloy forming the intermediate layer may be stamped, injection molded, or any other suitable manufacturing method may be considered.

According to an embodiment, it is an article comprising: an inner core; an outer layer; and an intermediate layer comprising an amorphous alloy, wherein a thickness of the intermediate layer is at most 0.1 mm; and wherein the intermediate layer is placed between the outer layer and the inner core. According to an embodiment of the article, the article is a golf ball.

According to an embodiment of the article, the intermediate layer is made in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the article, the intermediate layer is formed from longitudinal strips connecting the poles; and wherein the intermediate layer is made as a single piece configured to wrap around the article.

According to an embodiment of the article, the intermediate layer is formed as longitudinal strips connecting one of the poles and the equator; and wherein the intermediate layer is made as two pieces configured to wrap around the article. According to an embodiment of the article, the intermediate layer is glued to the inner core.

According to an embodiment of the article, the article further comprises an additional layer, wherein the additional layer comprises a geometric structure of a first material; wherein the geometric structure creates plurality of pockets for a second material; wherein the second material comprises a fluid; and wherein a pressure of the fluid is adjustable. According to an embodiment of the article, the geometric structure comprises a honeycomb pattern.

According to an embodiment of the article, the fluid is air. According to an embodiment of the article, the additional layer is placed between the inner core and the intermediate layer.

In an embodiment, the additional layer comprising geometric structure may not comprise any fluid and may be supporting the amorphous alloy layer.

According to an embodiment of the article, the outer layer comprises one or more of Urethane, Surlyn, and Balata.

According to an embodiment of the article, the inner core comprises one or more of polybutadiene, thermoplastic elastomers, liquid, and gel.

According to an embodiment of the article, the article features a dimple pattern on the outer layer.

According to an embodiment of the article, the thickness of the intermediate layer is 0.08 mm.

According to an embodiment of the article, the amorphous alloy comprises a Nickel-Based Brazing Foil comprising at least 75% Nickel by weight.

According to an embodiment of the article, the amorphous alloy comprises a Nickel-Based Brazing Foil comprising at least 85% Nickel by weight.

According to an embodiment, it is a method comprising: creating an inner core of an article; creating an intermediate layer comprising an amorphous alloy, wherein a thickness of the intermediate layer is at most 0.1 mm; and creating an outer layer enclosing the intermediate layer. According to an embodiment of the method, the article is a golf ball.

According to an embodiment of the method, the intermediate layer is made in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface, and the equator is an imaginary line that is perpendicular to the axis of the golf ball and equidistant from the poles and runs around a middle of the golf ball.

According to an embodiment of the method, the intermediate layer is formed from longitudinal strips connecting the poles; and wherein the intermediate layer is made as a single piece configured to wrap around the article.

According to an embodiment of the method, the intermediate layer is formed as longitudinal strips connecting one of the poles and the equator; and wherein the intermediate layer is made as two pieces configured to wrap around the article.

According to an embodiment of the method, the single piece and/or the two pieces are stamped in a predetermined shape.

According to an embodiment of the method, the amorphous alloy is cast as strips on a cold roller.

According to an embodiment of the method, the single piece or the two pieces are injection molded.

According to an embodiment of the method, the intermediate layer is glued to the inner core.

According to an embodiment of the method, the article further comprises an additional layer, wherein the additional layer comprises a geometric structure of a first material; wherein the geometric structure creates plurality of pockets for a second material; wherein the second material comprises a fluid; and wherein a pressure of the fluid is adjustable. According to an embodiment of the method, the geometric structure comprises a honeycomb pattern. According to an embodiment of the method, the fluid is air. According to an embodiment of the method, the additional layer is placed between the inner core and the intermediate layer.

According to an embodiment of the method, the outer layer comprises one or more of Urethane, Surlyn, and Balata.

According to an embodiment of the method, the inner core comprises one or more of polybutadiene, thermoplastic elastomers, liquid, and gel.

According to an embodiment of the method, the article features a dimple pattern on the outer layer.

According to an embodiment of the method, the amorphous alloy comprises a Nickel-Based Brazing Foil comprising at least 75% Nickel by weight. According to an embodiment of the method, the amorphous alloy comprises a Nickel-Based Brazing Foil comprising at least 85% Nickel by weight.

According to an embodiment of the method, the thickness of the intermediate layer is 0.08 mm.

There are four areas that are distinct in the current invention from the prior art documents including South Korean Patent Application Publication KR20010000252A:
i) Prior art discloses amorphous thin chips (peanut shaped/polygon shaped/other shapes) glued together onto a core. FIG. 7 shows an example of thin chips or shapes that are glued to form an amorphous layer in prior art. The negative effect of using small thin pieces as described in this disclosure is that most of the elastic energy is lost between the amorphous pieces at the intersections shown as 702 and 704. Short pieces of metal strip joined together by a polymer cannot load and unload the impact energy properly. As per the illustration 702 and 704 represent the boundary between the two amorphous shapes will disrupt the efficient spring effect.
ii) Prior art discloses thin strips or strings wound over a layer. Though prior art mentions small thin strips or fiber wound over a layer, since amorphous alloy strings have not been produced, it is nothing more than a theoretical wish list for reasons explained herein. It is not disclosed anywhere how “thin” the strips have to be, or which thicknesses are preferred. Given that thickness significantly influences both spring action and material properties and considering that the manufacturing processes and conditions necessary to achieve the required thicknesses are specific, it is impossible for a person of ordinary skill in the art to determine these thickness values without conducting appropriate experimentation. Further, the prior art discloses winding thin strips similar to the manufacturing method of the conventional balata ball without any further details or explanation. In general, in a balata ball, rubber threads are stretched and wound under tension around a core, creating a tightly wound structure that can store and release energy. The tension in these windings plays a role in determining the golf ball's behavior under compression. However, the amorphous alloy strips or threads cannot be construed to be manufactured like a balata ball because a) Amorphous alloys, while elastic to a certain degree, are brittle compared to rubber. When wound tightly around a core, they could fracture or crack under the tensile stress required to maintain tension in the windings. Rubber, by contrast, is highly flexible and capable of stretching significantly without breaking, making it ideal for creating wound-core structures that can store and release energy. b) The elasticity of rubber allows it to deform and return to its original shape without permanent damage, which is why it is ideal for wound-core designs like that in the balata golf ball. Amorphous alloys have a much smaller elastic range; once they reach their yield point, they undergo permanent deformation or fracture. This limits their ability to serve as a flexible winding material capable of storing and releasing energy over many cycles. c) Rubber threads can be stretched and wound under significant tension, easily conforming to the shape of the core. In contrast, amorphous alloy strips, being metallic, would likely need to be very thin to be able to be wound but also prone to cracking and damage due to their brittle nature. d) The rubber threads in a balata ball store energy primarily through their high elasticity and ability to stretch and recoil. Amorphous alloys can store energy elastically, but not to the same extent as rubber. Additionally, amorphous alloys do not have the same flexibility to release this energy in the same way rubber does, especially under high-frequency or repeated loading cycles, limiting practical usage of amorphous alloys in applications to rely on elastic energy storage through winding.

Winding thin strips of amorphous alloy in a manner similar to rubber thread winding, as that of the construction of balata golf balls, is not feasible due to the significant differences in material properties. Amorphous alloys thin strips are too brittle, have limited elasticity, and would be prone to failure under the mechanical stresses involved in winding. While rubber can stretch and return to its original shape, amorphous alloys would crack or deform, rendering them unsuitable for such a purpose.
iii) Prior art does not disclose the chemistry for thin sheets: The chemistries used for amorphous alloy in prior art documents, including South Korean Patent Application Publication KR20010000252A, result in bulk metallic glass formulation/bulk amorphous alloy formulations, and cannot be utilized to produce thin strips less than 0.5 mm. It is highly likely that those compositions cannot be produced in thin sections less than 0.3 mm. Small peanut shaped amorphous sheets/chips or any other shapes, including the shapes that are disclosed in prior art documents including South Patent Korean Application Publication KR20010000252A, are cut into plurality of pieces from bulk amorphous alloys and glued to the golf ball, but will not stay glued due to its amorphous alloy strength and its natural tendency to maintain original flatness. Further, the amorphous layer disclosed in South Korean Patent Application Publication KR20010000252A is a plate shape and is formed by mixing amorphous alloy powder with resin or rubber. The specified amorphous alloy powder mixed with polymers is impossible to form into shapes less than 0.1 mm thick. Amorphous alloy powders typically consist of particles that are at least a few microns in size. When mixed with polymers, the size of these particles relative to the desired dimensions, for example, less than 0.1 mm, creates challenges. The presence of alloy powder within the polymer matrix exacerbates challenges due to differences in thermal expansion, viscosity, and behavior under mechanical stress. Conventional processing techniques, such as injection molding, extrusion, and sintering have limitations when dealing with polymer-metal composite materials at such fine scales. Achieving accurate, consistent shapes smaller than 0.1 mm is extremely challenging with current technology.

The bulk forming chemistries listed by the prior art patent KR20010000252A tend to exhibit gradual increase in viscosity as temperature decreases. If these alloys are poured over a spinning copper cooled wheel, the thick viscosity keeps the alloy from forming a thin layer over the copper wheel. This can be illustrated by comparing the viscosity of milk vs. honey. Low viscosity alloys will quickly level or flatten out as the cooper wheel is turning. However, the viscosity of honey may require two sided rollers to maintain an even thickness. The most challenging task is to control the viscosity of the alloy that is increasing its viscosity by an order of magnitude during the strip casting process. Thick viscosity alloys would solidify well before the alloy can be rolled to thickness of less than 0.1 mm.

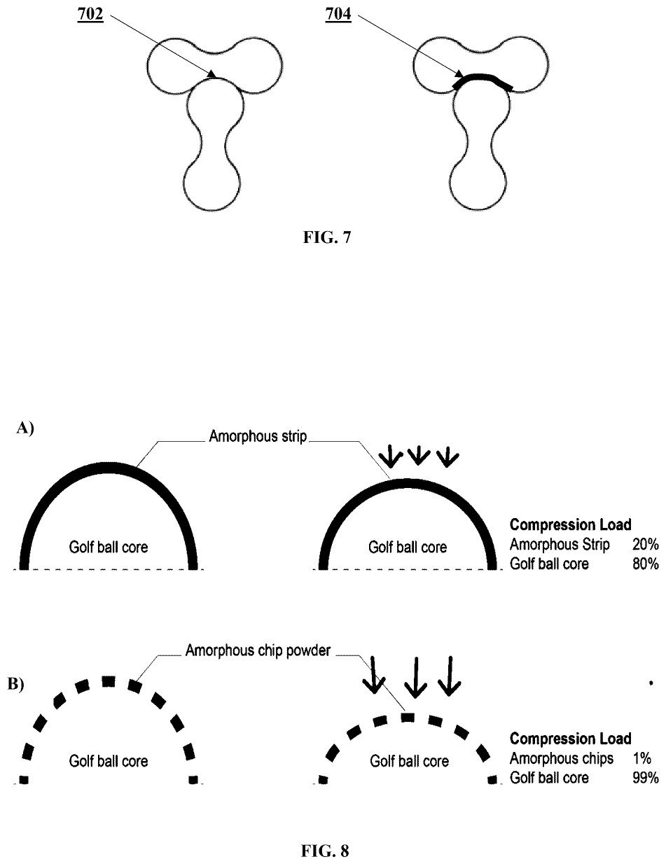

FIG. 8 shows golf ball behavior in compression for amorphous alloy strip layer, versus amorphous chip powder layer, wrapped around the golf core. FIG. 8 shows load taken by amorphous strip layer in case A and amorphous chip powder layer in case B. Amorphous strip layer in case A shows that in compression, that is when the golf head strikes the golf ball, the amorphous strip layer takes 20% of the load and the rest 80% goes to the core, in contrast, the amorphous chip powder layer in case B takes 1% of the load and the rest 99% goes to the core. The higher the load taken by the amorphous layer, the greater it will return the energy and hence have a good bounce after the strike force. If the energy goes to the core, the loss in energy is more, thus cutting off the distance traveled by the golf ball.

The prior art discloses that amorphous alloys are more efficient than polymers. However, the design comprising chips glued together does not take advantage of the amorphous materials. Therefore, it is highly unlikely that there are any improvements on spin rate and distance effects and no such discussion is present in prior art, nor are they able to provide test data that show clears distance advantage derived from the application of amorphous materials.
iv) The chemistry of Nickel (Ni) based composition is not disclosed in amorphous alloy compositions. Prior art discloses the composition where Ni, is maximum approximately up to 50% by weight. However, it is observed that compositions comprising higher nickel by weight percent contribute to enhanced properties of the amorphous material and for the material acting as a spring. Therefore, the compositions that are used in the current invention comprise Ni content to be over 70%. The compositions of the current invention are not Bulk Amorphous Alloys. In the prior art, Ni is included in bulk forming amorphous alloys. Also, it should be noted that the listing of chemistries in the prior art KR20010000252A disclosure is a random listing of elements. It is impossible for a person skilled in the art to practice or produce the product that was described and claimed in the prior art.

In the current application and in embodiments, preferably a single piece or two pieces are made out of amorphous material strips or sheets, such that the shape is able to be wrapped around the ball efficiently and then further glued to the core.

In an embodiment, the pieces are stamped. In an embodiment, the pieces are Laser cut. In an embodiment, the pieces are cut using electro discharge machining (EDM) process. In one embodiment, the pieces are cut using water jet cutting technology. In another embodiment, the pieces are photo or chemically etched. In other embodiments, the pieces may be cut using wire cut or even cut by hand using scissors. The entire length of the strip shown as 604, functions as one spring. It is more efficient to have compressive energy loaded over the entire surface with one continuous piece than multiple disconnected pieces.

In an embodiment, amorphous sheets that are less than or equal to 0.5 mm thick are used to form the amorphous alloy layer. In an embodiment, amorphous sheets that are less than or equal to 0.4 mm thick are used to form the amorphous alloy layer. In an embodiment, amorphous sheets that are less than or equal to 0.3 mm thick are used to form the amorphous alloy layer. In an embodiment, amorphous sheets that are less than or equal to 0.2 mm thick are used to form the amorphous alloy layer. In an embodiment, amorphous sheets that are less than or equal to 0.1 mm thick are used to form the amorphous alloy layer. In an embodiment, amorphous sheets that are 0.05 mm to 0.08 mm thick are used to form the amorphous alloy layer. In an embodiment, amorphous sheets that are 0.02 mm to 0.08 mm thick are used to form the amorphous alloy layer. In an embodiment, amorphous sheets that are 0.03 mm to 0.05 mm thick are used to form the amorphous alloy layer. In an embodiment, amorphous sheets that are 0.01 mm to 0.09 mm thick are used to form the amorphous alloy layer. In an embodiment, amorphous sheets that are 0.01 mm to 0.02 mm thick are used to form the amorphous alloy layer. In an embodiment, amorphous sheets that are 0.09 mm to 0.1 mm thick are used to form the amorphous alloy layer. In an embodiment, amorphous sheets that are 0.05 mm to 0.1 mm thick are used to form the amorphous alloy layer. In an embodiment, amorphous sheets that are 0.01 mm to 0.1 mm thick are used to form the amorphous alloy layer.

While attaching the amorphous layer for forming the golf ball, an extremely strong glue is used along with an external tape that stops the ends of the strips from getting detached.

In an embodiment, amorphous material comprises at least 55% Nickel by weight. In an embodiment, amorphous material comprises at least 60% Nickel by weight. In an embodiment, amorphous material comprises at least 65% Nickel, by weight. In an embodiment, amorphous material comprises at least 70% Nickel, by weight. In an embodiment, amorphous material comprises at least 75% Nickel, by weight. In an embodiment, amorphous material comprises at least 80% Nickel, by weight. In an embodiment, amorphous material comprises at least 85% Nickel, by weight. In an embodiment, amorphous material comprises at least 90% Nickel, by weight.

FIG. 9 shows an example of amorphous alloy materials and their compositions according to an embodiment. In an embodiment, amorphous alloy used is MBF15. In an embodiment, amorphous alloy used is MBF20. In an embodiment, amorphous alloy used is MBF30. In an embodiment, amorphous alloy used is MBF50. MBF15 comprises approximately 75 wt % Nickel. MBF20 comprises approximately 82 wt % Nickel. MBF30 comprises approximately 92 wt % Nickel. MBF50 comprises 72 wt % Nickel. In an embodiment, the amorphous alloy sheets or strips are sourced from METGLAS®.

MBF30 may be formed to be 0.08 mm thick. On the other hand, amorphous sheets using a spinning wheel cannot be produced in sections greater than 0.08 mm sheet. The optimal thickness of the amorphous sheet is between 0.05 mm to 0.1 mm. In an embodiment, the optimal thickness of the amorphous sheet is between 0.05 mm to 0.08 mm. Thicker alloy shifts moment of inertia to outer layer, effectively reducing spin rate. This effect alone can contribute up to 10 yards loss, even if the low spin rate is combined with a properly fitted higher lofted driver. These alloys are cast as strips on cold rollers. The maximum strip cast amorphous sheets are 0.08 mm. The thinnest injection molded amorphous sheets are in the 0.3 mm range. Thus, there is about a 4 times difference in thickness. Amorphous sheets that are greater than 0.1 mm are also likely to exhibit brittle failure modes. The listed amorphous alloys reflect the actual chemical compositions of non-bulk metallic glass formulations, rather than random assumptions about the potential capabilities of unspecified or arbitrarily listed amorphous compositions as mentioned in prior art, more particularly in prior art KR20010000252A. A person skilled in the art cannot produce an amorphous sheet of consistent thickness of less than 0.1 mm using Bulk Metallic Glass given the current state of technology. There are a handful of companies, Protech® of Korea, Samsung® Electronics, and other big industries, that spent millions and yet failed for the reasons listed.

According to an embodiment, it is an article comprising: an inner core; an outer layer; and an intermediate layer comprising an amorphous alloy, wherein the amorphous alloy comprises Nickel; and wherein the intermediate layer is placed between the outer layer and the inner core. According to an embodiment of the article, the article is a golf ball.

According to an embodiment of the article, the intermediate layer is made in a shape to wrap around the golf ball, wherein the shape is in a form of a gore, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the article, the intermediate layer is formed from longitudinal strips connecting the poles; and wherein the intermediate layer is made as a single piece configured to wrap around the article.

According to an embodiment of the article, the intermediate layer is formed as longitudinal strips connecting one of the poles and the equator; and wherein the intermediate layer is made as two pieces configured to wrap around the article.

According to an embodiment of the article, the intermediate layer is glued to the inner core.

According to an embodiment of the article, the article further comprises an additional layer, wherein the additional layer comprises a geometric structure of a first material; wherein the geometric structure creates plurality of pockets for a second material; wherein the second material comprises a fluid; and wherein a pressure of the fluid is adjustable. According to an embodiment of the article, the geometric structure comprises a honeycomb pattern. According to an embodiment of the article, the fluid is air. According to an embodiment of the article, the additional layer is placed between the inner core and the intermediate layer.

According to an embodiment of the article, the outer layer comprises one or more of Urethane, Surlyn, and Balata.

According to an embodiment of the article, the inner core comprises one or more of polybutadiene, thermoplastic elastomers, Liquid, and gel.

According to an embodiment of the article, the article features a dimple designs on the outer layer.

According to an embodiment of the article, the amorphous alloy comprises in percentage weights Boron 1-5%, Chromium 5-10%, Iron 1-5%, Nickel 75-92%, Silicon 1-5%, and a possible trace of Cobalt impurity.

According to an embodiment of the article, the amorphous alloy comprises in percentage weights Boron 1-5%, Iron 0-0.5%, Nickel 85-95%, Silicon 1-5% and a possible trace of Cobalt impurity.

According to an embodiment of the article, wherein a thickness of the intermediate layer is at most 0.1 mm.

According to an embodiment of the article, the thickness of the intermediate layer is 0.08 mm.

According to an embodiment, it is a method comprising: creating an inner core of an article; creating an intermediate layer comprising an amorphous alloy, wherein the amorphous alloy comprises Nickel; and creating an outer layer enclosing the intermediate layer. According to an embodiment of the method, the article is a golf ball.

According to an embodiment of the method, the intermediate layer is stamped in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

According to an embodiment of the method, the intermediate layer is formed from longitudinal strips connecting the poles; and wherein the intermediate layer is made as a single piece configured to wrap around the article.

According to an embodiment of the method, the intermediate layer is formed as longitudinal strips connecting one of the poles and the equator; and wherein the intermediate layer is made as two pieces configured to wrap around the article.

According to an embodiment of the method, the intermediate layer is stamped.

According to an embodiment of the method, the amorphous alloy is cast as strips on a cold roller.

According to an embodiment of the method, pieces of the intermediate layer is injection molded. According to an embodiment of the method, the intermediate layer is glued to the inner core.

According to an embodiment of the method, the article further comprises an additional layer; wherein the additional layer comprises a geometric structure of a first material; wherein the geometric structure creates plurality of pockets for a second material; wherein the second material comprises a fluid; and wherein a pressure of the fluid is adjustable. According to an embodiment of the method, the geometric structure comprises a honeycomb pattern. According to an embodiment of the method, the fluid is air. According to an embodiment of the method, the additional layer is placed between the inner core and the intermediate layer.

According to an embodiment of the method, the outer layer comprises one or more of Urethane, Surlyn, and Balata.

According to an embodiment of the method, the inner core comprises one or more of polybutadiene, thermoplastic elastomers, Liquid, and gel.

According to an embodiment of the method, the article features dimple designs on the outer layer.

According to an embodiment of the method, the amorphous alloy comprises in percentage weights Boron 1-5%, Chromium 5-10%, Iron 1-5%, Nickel 75-92%, Silicon 1-5%, and a possible trace of Cobalt impurity.

According to an embodiment of the method, the amorphous alloy comprises in percentage weights Boron 1-5%, Iron 0-0.5%, Nickel 85-95%, Silicon 1-5% and a possible trace of Cobalt impurity.

According to an embodiment of the method, wherein a thickness of the intermediate layer is at most 0.1 mm.

According to an embodiment of the method, the thickness of the intermediate layer is 0.08 mm.

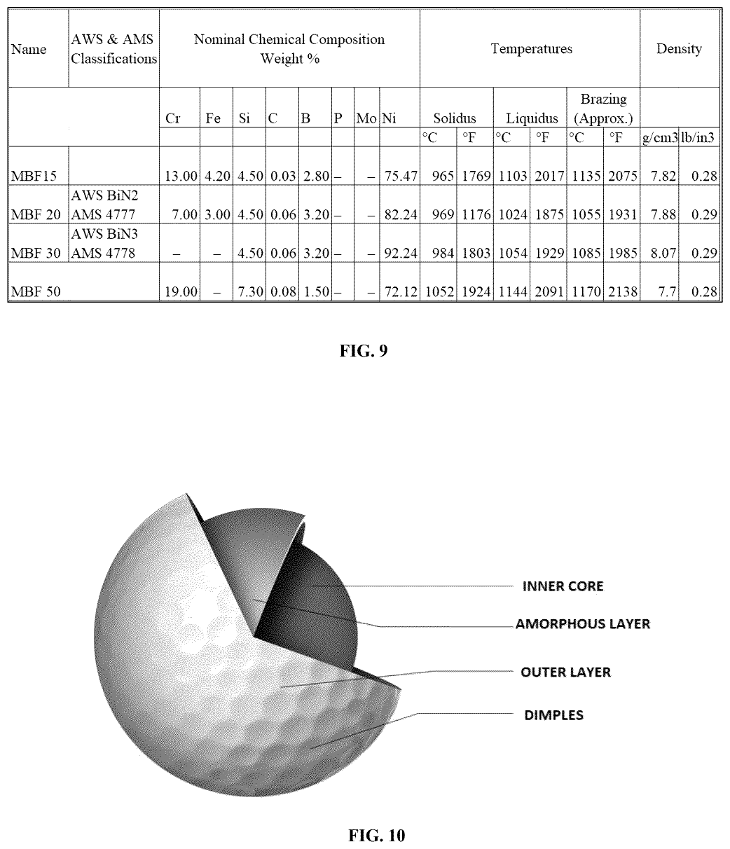

FIG. 10 shows an example of a golf ball comprising an amorphous layer according to an embodiment. The golf ball comprises an inner core, amorphous layer, and an outer layer. The amorphous layer is between the inner core and the outer layer. The outer layer further comprises dimples to reduce drag.

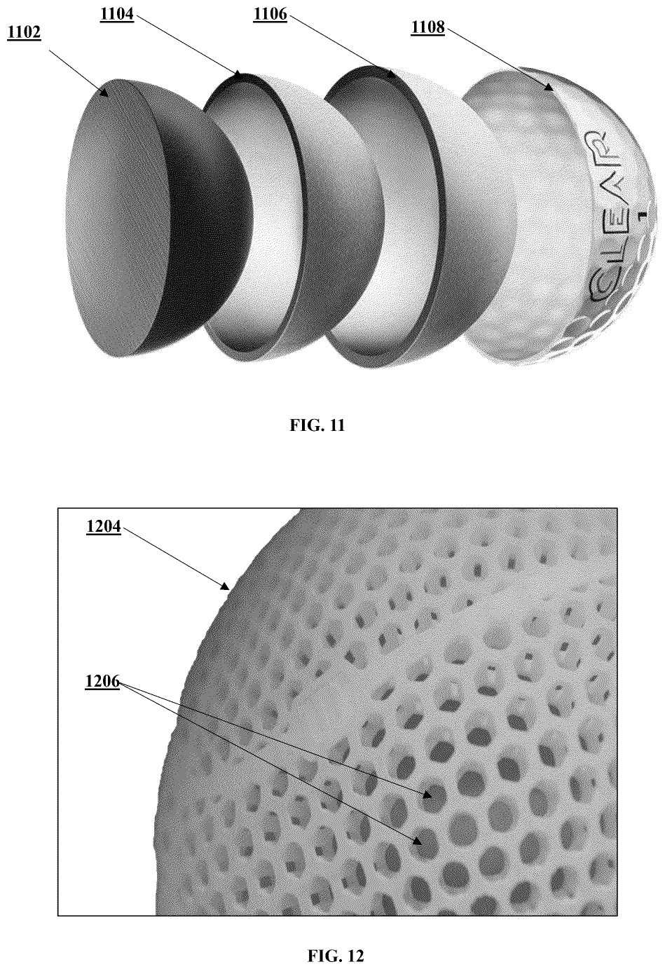

Air As Structure: In an embodiment, air is used as a structure. Air is highly efficient at storing and returning energy. A method to connect the amorphous metallic layer to its inner layer in such a way that the amorphous layer stores a greater percentage of compressive energy will result in higher efficiency of net energy transfer to ball velocity. FIG. 11 shows an example golf ball comprising an amorphous layer and a geometric structure according to an embodiment. As shown, the golf ball comprises an inner core 1102, a geometric structure layer 1104, an amorphous layer 1106, and an outer layer 1108. FIG. 12 shows an example geometric structure layer according to an embodiment. The geometric structure layer 1204 may be a honeycomb structure that is configured to be filled with air in the honeycomb pocket 1206, thus forming a layer of air pockets. Layer of Air Pockets can minimize the loss of energy during impact. It is as if hundreds of little basketballs are storing and returning the compressed energy. The compressed air can return significantly higher percentage of stored energy to the surface than can be accomplished by synthetic polymers. By adjusting the pressure within the honeycomb structure, the Coefficient of Restitution can be adjusted. The mechanism for adjusting the pressure can be similar to that of an air fillable ball where a valve is provided and configured to be filled with the air. The honeycomb structure may have interconnections that can make air flow from one honeycomb pocket to another honeycomb pocket. This can be illustrated by a basketball that is inflated to different pressures. The higher the pressure, the higher the bounce height of the ball. A honeycomb structure that functions as multiple micro balloons that support the amorphous alloy layer with less lost momentum.

The layer below the amorphous alloy layer 1106 towards the inner core 1102 could be the geometric structure layer 1104 that further minimizes loss of energy, while allowing the amorphous alloy layer 1106 to store and return maximum energy. Honeycomb structures, such as shown in FIG. 12, create air bubbles which minimize energy loss. In an embodiment, the golf balls may not have the geometric structure layer 1104 that incorporates the air or fluid filled layers below the amorphous alloys layer 1106. In an embodiment, the sequence of layers is such that the amorphous alloy layer 1106 is immediately below the outer layer 1108, and the geometric structure layer 1104 is immediately below the amorphous alloys layer 1106, and the inner core 1102 is immediately below the geometric structure layer 1104.

According to an embodiment, it is an article comprising: a first layer comprising a geometric structure of a first material, wherein the geometric structure creates plurality of pockets for a second material; a second layer comprising a third material, wherein the third material comprises an amorphous alloy; and wherein the second material comprises a fluid, wherein a pressure of the fluid is adjustable; and wherein the first layer and the second layer are placed between an outer layer and an inner core. According to an embodiment of the article, the article is a golf ball.

According to an embodiment of the article, the second layer is immediate after the first layer; wherein the second layer is closer to the outer layer relative to the first layer. According to an embodiment of the article, the first layer has a first thickness, wherein the second layer has a second thickness. According to an embodiment of the article, the first material has a first hardness, wherein the second material has a second hardness, and wherein the first hardness is different from the second hardness. According to an embodiment of the article, the first material has a first toughness, wherein the second material has a second toughness, and wherein the first toughness is different from the second toughness. According to an embodiment of the article, the first material has a first compressibility, wherein the second material has a second compressibility, and wherein the first compressibility is different from the second compressibility.

According to an embodiment of the article, the geometric structure comprises one of a hexagon, a square, a triangle, a polygon, a pentagon, a peanut shape, a dumbbell shape, and a rhombus. According to an embodiment of the article, the geometric structure comprises a honeycomb pattern.

According to an embodiment of the article, the fluid is a compressible fluid. According to an embodiment of the article, the fluid comprises air.

According to an embodiment of the article, the fluid is an incompressible fluid. According to an embodiment of the article, the fluid comprises one of glycerin, oil, water solution, and gel.

According to an embodiment of the article, a variation in the pressure of the fluid changes the Coefficient of Restitution of the article.

According to an embodiment of the article, the outer layer comprises one or more of Urethane, Surlyn, and Balata.

According to an embodiment of the article, the inner core comprises one or more of polybutadiene, thermoplastic elastomers, Liquid, and gel.

According to an embodiment of the article, the article features a dimple design on the outer layer.

According to an embodiment of the article, the article further comprises a valve assembly adapted to receive a pump nozzle for introducing air into the article to adjust an internal pressure of the article.

According to an embodiment of the article, the first layer and the second layer are integral.

According to an embodiment of the article, the amorphous alloy comprises bulk metallic glass.

According to an embodiment of the article, the amorphous alloy comprises one or more silica and silica-based glass sheets.

According to an embodiment of the article, the amorphous alloy comprises iron based amorphous ribbons. According to an embodiment of the article, the iron based amorphous ribbons comprise, by weight percent, iron in a first range of 84-100%, silicon in a second range of 0-10%, boron in a third range of 0-5%, and manganese in a fourth range of 0-2%. According to an embodiment of the article, the iron based amorphous ribbons comprise iron in a first range of 0-100%, cobalt in a second a second range of 0-85%, Nickel in a third range of 0-50%, silicon in a fourth range of 0-10%, molybdenum in a fifth range of 0-8%, boron in a sixth range of 0-5%, and manganese in a seventh range of 0-2%.

According to an embodiment of the article, the amorphous alloy has an elastic strain limit of at least 1.5% selected from (Zr,Ti)ₐ(Ni,Cu,Fe)_{b}(Be,Al,Si,B)_{c} wherein a=30-75; b=5-60 & c=0-50 atomic percentages; (Zr,Ti)ₐ(Ni,Cu)_{b}(Be)_{c} wherein a=40-75; b=5-50; & c=5-50 in atomic percentages; (Zr,Ti)ₐ(Ni,Cu)_{b}(Be)_{c} wherein a=40-65; b=7.5-35; & c=10-37.5 in atomic percentages; and (Zr)ₐ(Nb,Ti)_{b}(Ni,Cu)_{c}(Al)_{d} and wherein a=45-65; b=0-10; c=20-40; and d=7.5-15.

According to an embodiment of the article, the amorphous alloy comprises one of a Zr-based alloy, a Ti-based alloy, a Zr—Ti-based alloy, an Fe-based alloy, and combinations thereof.

According to an embodiment of the article, the amorphous alloy is at least substantially free of Be.

According to an embodiment, it is a method comprising: creating an inner core of an article; creating a first layer enclosing the inner core, wherein the first layer comprises a geometric structure, wherein the geometric structure creates one or more pockets for a fluid; creating a second layer comprising an amorphous alloy material; creating an outer layer enclosing the second layer; and filling the fluid in the pockets until a predetermined pressure in the article is attained. According to an embodiment of the method the article is a golf ball.

### Optimized Spring Action Timing

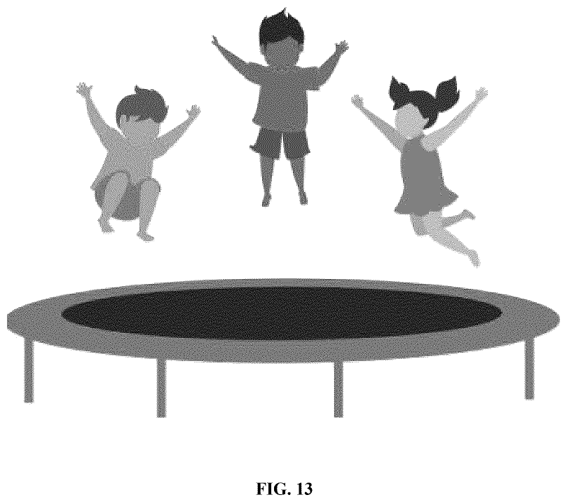

(Impedance Matching): The term “impedance matching” though primarily used in electrical engineering, in the current context, it is used to metaphorically describe how optimizing the interaction between two objects (golf ball and the club face) or actions (release of the compressed energy between the golf ball and the club face) ensures maximum transfer of energy and performance. Since amorphous alloys are metallic, they can be designed to optimize and match the timing of the ball and the club face releasing their respective compressed energy. A golf ball constructed with an amorphous metallic layer, right below the Urethane top layer, is more efficient than polymers at storing and returning energy. The energy stored in the club face and the ball would release at the optimal time sequence that maximum energy is transferred to generate ball velocity. This action can be best visualized by an athlete's attempt to maximize height generated on a trampoline. FIG. 13 shows athletes jumping on a trampoline according to an embodiment. The athlete times his jump with the unloading of the energy stored on the trampoline surface. If this timing is off, the athlete's own jump can result in minimal height gain. The structure of the amorphous layer may be designed to minimize the compression and energy storage of the core below the metallic layer.

### Results

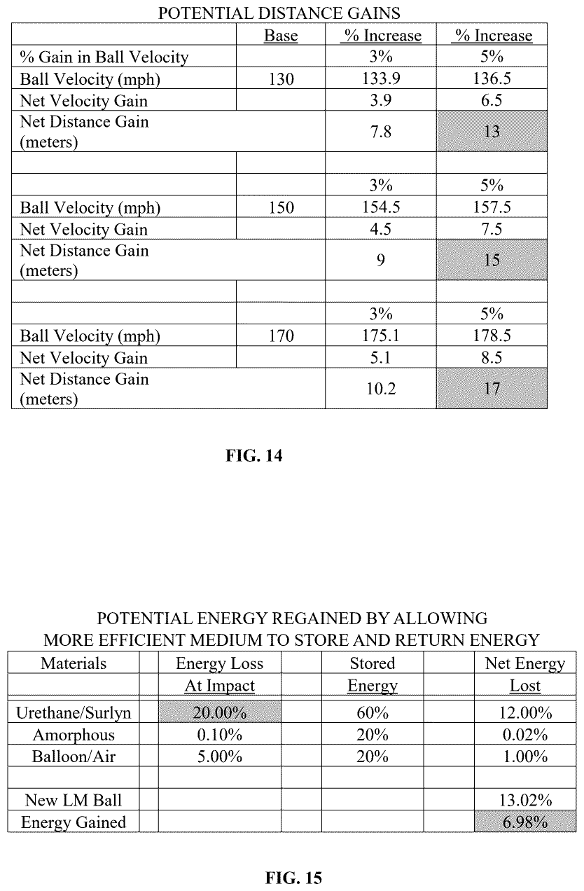

FIG. 14 shows the potential net gain in distance as the initial velocity of the ball coming off the face of the club according to an embodiment. The table provided analyzes the relationship between ball velocity and the resulting net distance gain for golf balls comprising amorphous alloy layer in two scenarios where the ball velocity of 3% and 5% is gained. The potential net gain in distance as the initial velocity of the ball coming off the face of the club increased between 3% and 5% is shown. A 3% increase gives a net velocity gain of 3.9 miles per hour (mph) (133.9-130). A 5% increase gives a net velocity gain of 6.5 mph (136.5-130). Similar calculations can be performed for velocities of 150 mph and 170 mph. For 130 mph, the net distance gains are 9 meters (3% increase) and 15 meters (5% increase). For 150 mph, the net distance gains are 9 meters (3% increase) and 15 meters (5% increase). For 170 mph, the net distance gains are 10.2 meters (3%) and 17 meters (5%).

By transferring the storage and release of the impact energy to materials and structures that are more efficient than solid polymers currently used in golf balls, an additional 3% to 8% of the energy can be returned to the ball. A flexible and thin golf club surface also can carry some of the energy at impact and return the energy more efficiently than what can be achieved by the current golf ball polymers. This is the reason USGA limits the COR (Coefficient of Restitution) of drivers.

### Soft and Long

Reduce lost energy from friction within the ball: The friction between the ball cover and the club face, as well as the angle of impact, affects backspin rate. Thus, softer Urethane cover and softer cores are preferred by low handicap players for their ability to dig into the club face and generate significant backspin. The softer Urethane top layer can be supported by an amorphous alloy layer, which in turn is supported by an air layer to maximize ball velocity and optimize backspin rates.

Reduce Spin Rates on Drives for longer Distance: A hollow sphere has a larger rotational inertia as compared to a solid sphere of the same mass and radius. Since both spheres experience the same torque, the sphere with the smaller rotational inertia will spin faster. In the case of golf balls, if greater weight is distributed to the outer layer, the moment of inertia increases, and the golf ball will spin slower.

Less Spin for Maximum Driver Distance: Drivers interact with golf balls more squarely than irons. Thus, the surface interface between the ball and club will play a less dominant role and the conservation of angular momentum affects spin rates. Reduction in spin rates on drivers can significantly affect the lost distance experienced by traditional high spin balls. In addition to the greater ball flight distance, a significant distance gain can be achieved through rolling an additional 15 to 20 yards after landing.

Increase Spin Rates on Shorter Iron Shots for better Control: This is specifically in the case of “hard” golf balls that are difficult to generate backspin on shorter iron shots. Surlyn® and high compression cores will not bite into the groove of irons and will not spin sufficiently to generate backspin.

A golf ball that combines the softer top layer for maximum spin and feel on irons shots but reduces spin for distance shots combines the best of both objectives.

FIG. 15 shows potential energy regained by different materials used in forming the layers of a golf ball to store and return energy. The “materials” column lists Urethane/Surlyn®, Amorphous material, Balloon/Air, and a new design referred to as “New LM Ball”, where LM stands for Liquidmetal® comprising all the above three layers as explained in FIG. 11. The column “Energy Loss at Impact’ represents the percentage of energy lost when the material undergoes an impact. This loss could be due to factors like deformation, friction, or heat dissipation. As shown, Urethane/Surly® loses 20% of the energy upon impact, the amorphous material loses only 0.10%, which is almost negligible, and Balloon/Air loses 5% of the energy. The percentage of energy stored by the material after impact shown in “stored energy” column, which can be used to “return” the energy, i.e., to aid in rebound or recovery is where Urethane/Surlyn® stores 60% of the energy, Amorphous material stores 20% of the energy, and Balloon/Air stores 20% of the energy. The “net energy lost” column shows the total percentage of energy that is lost after accounting for both the energy loss at impact and the stored energy. This is calculated by subtracting the stored energy from the energy loss. For example: for Urethane/Surlyn® has a net energy loss of 12%, which is calculated as (60%×20%)=12%. Similarly, the amorphous material has a net energy loss of 0.02%, which is minimal. Balloon/Air loses 1% of the energy. The “New LM Ball” that incorporates the above three material layers optimizes energy retention and minimizes energy loss, where the net energy loss is 13.02% (12%+0.02%+1.00%). For irons and smaller woods, where little face deflection is possible and most of the energy of the impact is stored within the ball, the net energy loss is approximately 20%. Therefore, total energy gain shown in column “energy gained” due to the amorphous layer and air-filled layer for this “New LM Ball” is 6.98% (which is 20%-13.02%).

### Optimal Backspin and Launch Angle

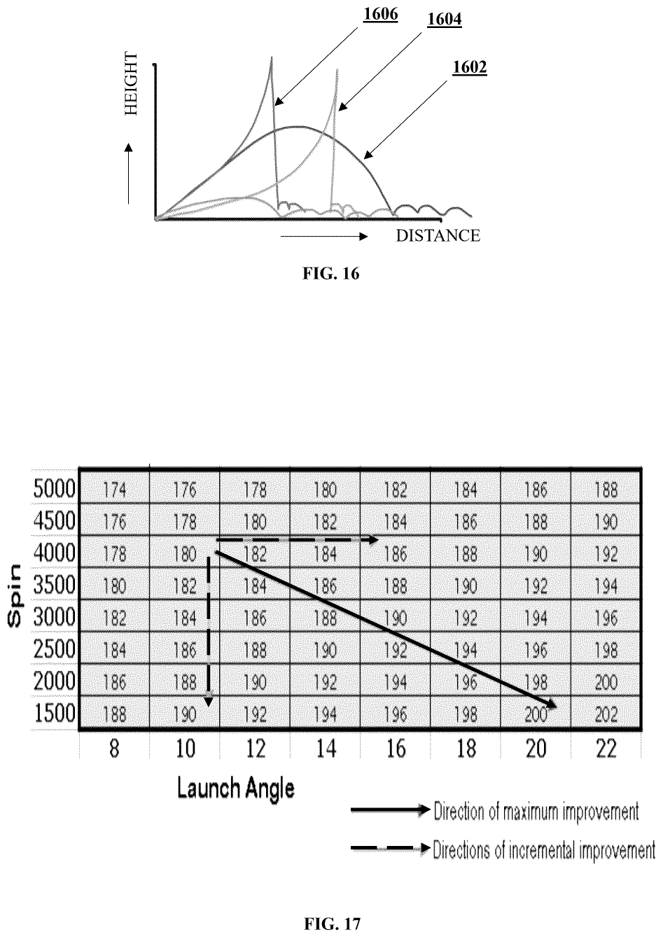

FIG. 16 shows a relation between launch angle and spin rate according to an embodiment. Trajectory 1606 shows a high spin rate ball struck with a high lofted club. Trajectory 1604 shows a high spin rate ball struck with low lofted club. Trajectory 1602 shows a low spin rate ball struck with high lofted club. Reduction in spin on drives allows higher lofted drivers to be used to utilize higher launch angles as shown by the 1602 trajectory. Trajectory 1602 shows a high launch angle, and low backspin produces maximum distance. Trajectories 1604 and 1606 show where most drivers generate excessive backspin. Reducing backspin allows optimal launch angles that optimize drive distance.

FIG. 17 shows a table showing the relation of launch angle and spin rate according to an embodiment. The figure shows a matrix for understanding the relationship between different combinations of variables, launch angle (in degrees) and backspin (in revolutions per minute or rpm) affect the distance a ball travels, measured in yards, and their effect on ball distance, which could be relevant in golf or similar ball-launching scenarios. The horizontal axis shows the launch angle in degrees, ranging from 8° to 22°. The vertical axis represents the spin rate of the ball in revolutions per minute (rpm), ranging from 1,500 to 5,000 rpm. The values inside the matrix represent the distance in yards that the ball will travel for a given combination of launch angle and spin rate. For instance, at a launch angle of 10° and spin rate of 4,000 rpm, the ball will travel 180 yards; at a launch angle of 14° and spin rate of 2,000 rpm, the ball will travel 190 yards.

Two arrows indicate the directions of maximum improvement and incremental improvement: i) The diagonal arrow moving downward from the top right toward the bottom left indicates the direction of maximum improvement, suggesting that reducing spin while increasing the launch angle yields the greatest gains in distance. ii) The horizontal arrow and/or vertical arrow shows the direction of incremental improvement along the matrix, suggesting that small increases in distance can also be achieved by optimizing the launch angle while keeping spin more or less constant or vice-versa.

Optimizing both launch angle and spin can significantly affect the distance traveled by the ball. Increasing the launch angle while simultaneously reducing spin yields the best results, as shown by the maximum improvement direction. High spin limits distance, even with high launch angles, is likely due to increased air resistance and a steeper descent caused by the backspin. Conversely, low spin with high launch angles produces the maximum distance. For maximum distance of drives, higher launch angle and lower backspin rate are preferred. Not only will the ball with less backspin fly further, but it can also roll an additional 10 meters after it lands.

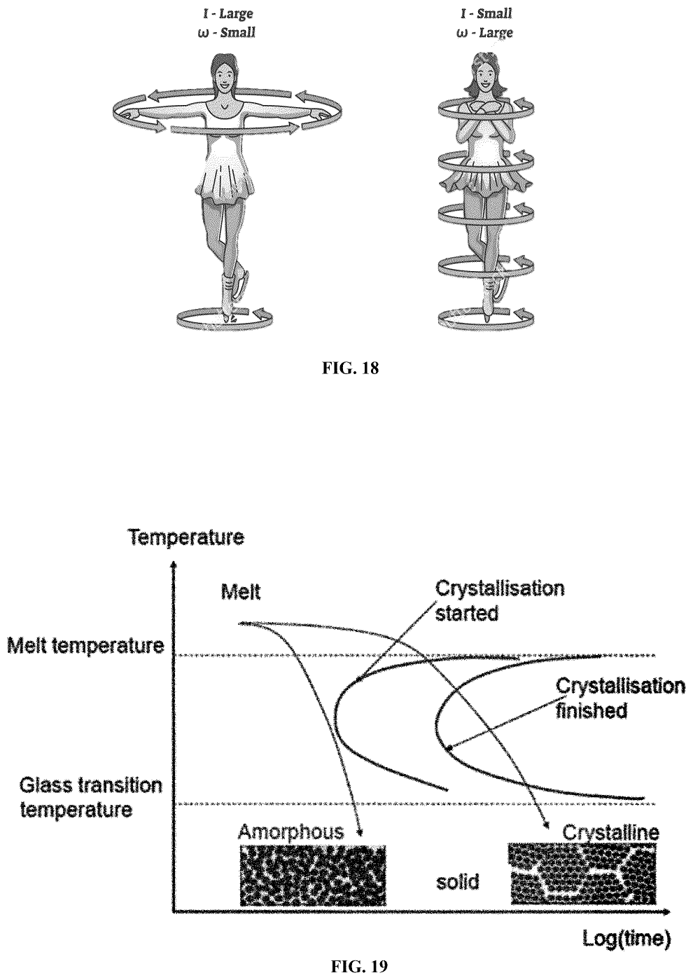

FIG. 18 shows an example of the law of conservation of momentum according to an embodiment. The image illustrates the concept of conservation of angular momentum using a figure skater as an example. The key idea here is that angular momentum, represented by the symbol L, is conserved in a system where no external torque acts. Angular momentum (L) is the product of an object's moment of inertia (I) and its angular velocity (ω). The skater with her arms extended outward increases her moment of inertia (I). The moment of inertia depends on how mass is distributed relative to the axis of rotation. When the mass (in this case, her arms) is spread out, the moment of inertia is larger. To conserve angular momentum, her angular velocity (ω), or the speed at which she is rotating, is smaller when the moment of inertia is large. This is why she rotates more slowly when her arms are extended. The skater who has pulled her arms inward, reduces her moment of inertia (I). By bringing the mass closer to the axis of rotation, the moment of inertia decreases. Due to the conservation of angular momentum, the angular velocity (ω) increases to compensate for the smaller moment of inertia. As a result, the skater spins faster when her arms are pulled in.

Similarly, the same ball which spins less and goes further, on drives, will generate high spin rates for shorter irons shots. The soft cover overcomes the rotational inertia of having greater weight being away from the core. The spin rate off a driver generally ranges between 2,000 and 4,000 rpm, while the average, cleanly struck wedge shot spins at about 10,000 rpm. The Urethane cover is softer but will have less spin effect off drivers as it strikes the club face squarely and generates less spin. The greater the moment of inertia, less spin is generated. Thus, the heavier amorphous alloy layer being placed closer to the surface will reduce spin rate, all things being equal. However, for shorter clubs and wedges, the softer Urethane cover will dig into the grooves of the irons and generate a high spin rate, resulting in shots where the ball stops close to its landing zone.

When comparing the rebound speeds, hardballs bounce back about 80% of the distance, while professional softballs, covered in a layer of polymer, only manage about 70 to 75%. This indicates a 10% difference in performance, largely due to the polymers being inefficient in the compression and decompression cycle. One aim is to address this issue by incorporating a layer of amorphous alloy strips within the ball to minimize energy loss. Instead of relying on polymers for spring action, using Liquidmetal® offers superior energy retention. Even if the amorphous alloy strips were to rebound fully, the presence of the polymer layer, which loses 20 to 25% of its energy during compression, would significantly hinder its effectiveness. Although amorphous alloy strips may not achieve perfect energy return, the key feature lies in a pattern in the amorphous alloy strips layer. One idea involves integrating a honeycomb structure and generating small pockets of air, akin to having miniature basketballs within. The rationale behind this is that compressed air stands out as one of the most efficient methods for storing and returning energy without significant loss.

Despite its incompressible nature, liquid (instead of air in the pockets) poses a challenge when it comes to functioning as a spring. However, it remains a viable option to explore for integration due to its unique properties, albeit not ideal as a traditional spring mechanism.

Integrating a honeycomb structure and generating small pockets of air, akin to having miniature basketballs within the golf ball structure, then when filled with enough air to create enough pressure, it bounces significantly higher. However, if the air is removed, its bouncing ability diminishes. That is the concept. Additionally, adjusting the moment of inertia, similar to an ice skater moving their weight closer to the surface, typically reduces friction. The idea revolves around incorporating either a honeycomb structure or a thin layer of ribbon, arranged strategically to cover the ball thoroughly, then applying a urethane cover layer on top.

FIG. 19 shows a schematic Time-Temperature-Transformation (TTT) diagram that shows crystallization kinetics of amorphous metals vs. crystalline metals. Amorphous metals are a new class of materials that have a disordered, non-crystalline, glassy structure, lacking long-range periodicity of the atomic arrangement, which are created when metals or their alloys are either cooled very quickly or because of a unique alloy combination, bypassing crystallization during solidification. FIG. 19 shows the time-temperature-transformation (TTT) solidifying diagram of an exemplary amorphous alloy and a crystalline alloy. The C shape of crystalline materials in TTT diagram is the result of the competition between the increasing driving force for crystallization and the slowing of kinetics (effective diffusivity) of the atoms. Both thermodynamic and kinetic parameters affect the crystallization and shift the C shape position to larger times.

The position of the nose determines the critical cooling rate to avoid nucleation and crustal growth during cooling and defines the conditions to manufacture amorphous alloys. In case of amorphous alloys instead of liquid/solid crystallization transformation, the molten material becomes more viscous as the temperature reduces near to the glass transformation temperature and transforms to a solid state after this temperature. In the liquid state, the atoms vibrate around positions and have no long-range ordering. Hence, the critical cooling rate is determined by atomic fluctuations, controlled by thermodynamic factors, rather than kinetic factors. Due to the crystallization bypass, the amorphous alloys retain the most prominent characteristic of the liquid, the absence of a typical long-range ordered pattern of the atomic structure of crystalline alloys and any defects associated with it. This disordered, dense atomic arrangement determines the unique structural and functional properties of amorphous alloys.

Due to their unique microstructure, amorphous metals combine high corrosion resistance, high strength, high hardness, and substantial ductility in one single metal. The unique properties of amorphous metals come from the lack of long-range periodicity, related grain boundaries and crystal defects such as dislocations. There has been a limitation regarding manufacturing net-shape components with amorphous metals until only recently with the additive manufacturing. Traditionally, components were limited in thickness to 3-5 mm due to the fast-cooling rate requirement of the alloy (critical casting thickness).

An amorphous alloy (or metallic glass) refers to a metal alloy that lacks a long-range crystalline structure, typically achieved through rapid cooling. The atoms in an amorphous alloy are arranged in a disordered manner, unlike the regular, repeating patterns found in crystalline metals. Amorphous alloys are generally produced in thin layers or small sections because achieving the necessary cooling rates (approximately 10⁶ K/s or higher) to prevent crystallization is easier in these small-scale geometries. Common examples include thin films, ribbons, and coatings. A bulk amorphous alloy refers to a larger-sized amorphous alloy that can maintain its amorphous structure over much thicker dimensions, often in millimeter or centimeter scales. These materials are also known as bulk metallic glasses (BMGs). Bulk Metallic Glass materials cannot be strip cast to less than 0.1 mm thick. The chemistries used for amorphous strips of less than 0.1 mm thickness have low viscosity. The process of strip casting thin sheets uses a process where highly fluid molten alloy is poured over a water chilled copper spinning wheel to solidify rapidly. Very specific compositions of amorphous alloys will be formed into thin sheets, while maintaining amorphous atomic structure. Due to the high cooling rates required to keep the strips in crystallized form, the maximum thickness that may be commercially produced may be around 0.08 mm. Any thickness above 0.8 mm results in insufficient cooling and crystallization of the material. The cooling rate required for these amorphous strips is above 5,000 C degrees per second. The low viscosity of the compositions, as listed in MBF25, MBF20, MBF30, MBF50 produced by MetGlas®, allows the amorphous sheet to maintain a consistent thin cross section.

The descriptions of the one or more embodiments are for purposes of illustration but are not exhaustive or limiting to the embodiments described herein. Many modifications and variations will be apparent to those of ordinary skill in the art without departing from the scope and spirit of the embodiments described. The terminology used herein best explains the principles of the embodiments, the practical application and/or technical improvement over technologies found in the marketplace, and/or enable others of ordinary skill in the art to understand the embodiments described herein.

### INCORPORATION BY REFERENCE

All references, including granted patents and patent application publications, referred herein are incorporated herein by reference in their entirety.

U.S. Patent Publication US20130324322A1, titled, “Golf Ball with Lattice Reinforced Layer”.
U.S. Patent Publication US20100075776A1, titled, “Golf ball with improved flight performance”.

1-72. (canceled)

73. An article comprising:
an inner core; an outer layer; and
an intermediate layer comprising an amorphous alloy, wherein a thickness of the intermediate layer is at most 0.1 mm; and
wherein the intermediate layer is placed between the outer layer and the inner core.

74. The article of claim 73, wherein the article is a golf ball.

75. The article of claim 74, wherein the intermediate layer is made in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

76. The article of claim 75, wherein the intermediate layer is formed from longitudinal strips connecting the poles; and wherein the intermediate layer is made as a single piece configured to wrap around the article.

77. The article of claim 75, wherein the intermediate layer is formed as longitudinal strips connecting one of the poles and the equator; and wherein the intermediate layer is made as two pieces configured to wrap around the article.

78. The article of claim 73, wherein the article further comprises an additional layer, wherein the additional layer comprises a geometric structure of a first material; wherein the geometric structure creates plurality of pockets for a second material; wherein the second material comprises a fluid; and wherein a pressure of the fluid is adjustable; and wherein the geometric structure comprises a honeycomb pattern; and wherein the additional layer is placed between the inner core and the intermediate layer.

79. The article of claim 78, wherein the fluid is air.

80. The article of claim 73, wherein the outer layer comprises one or more of Urethane, Surlyn, and Balata; and wherein the article features a dimple design on the outer layer.

81. The article of claim 73, wherein the inner core comprises one or more of polybutadiene, thermoplastic elastomers, Liquid, and gel.

82. The article of claim 73, wherein the thickness of the intermediate layer is in a range of 0.05 mm and 0.08 mm.

83. The article of claim 73, wherein the amorphous alloy comprises a Nickel-Based Brazing Foil comprising at least 75% Nickel by weight.

84. A method comprising:
creating an inner core of an article;
creating an intermediate layer comprising an amorphous alloy, wherein a thickness of the intermediate layer is at most 0.1 mm; and
creating an outer layer enclosing the intermediate layer.

85. The method of claim 84, wherein the article is a golf ball.

86. The method of claim 85, wherein the intermediate layer is made in a shape to wrap around the golf ball, wherein the shape is in a form of gores, where gores are wedge-shaped strips narrowing toward poles and wider at an equator; and wherein the poles are two points on a surface of the golf ball where an axis of rotation intersects the surface and the equator is an imaginary line that is perpendicular to the axis of the golf ball and equidistant from the poles and runs around a middle of the golf ball.

87. The method of claim 86, wherein the intermediate layer is formed from longitudinal strips connecting the poles; and wherein the intermediate layer is made as a single piece configured to wrap around the article.

88. The method of claim 86, wherein the intermediate layer is formed as longitudinal strips connecting one of the poles and the equator; and wherein the intermediate layer is made as two pieces configured to wrap around the article.

89. The method of claim 84, wherein the intermediate layer is cast as strips on a cold roller; and stamped to a predetermined shape.

90. The method of claim 84, wherein the intermediate layer is injection molded to a predetermined shape.

91. The method of claim 84, wherein the intermediate layer is glued to the inner core.

92. The method of claim 84, wherein the thickness of the intermediate layer is in a range of 0.05 mm and 0.08 mm.
